(19) United States
(12) Patent Application Publication
(10) Pub. No.: US 2008/0103953 A1
(43) Pub. Date: May 1, 2008

(54) TOOL FOR OPTIMIZING ADVERTISING ACROSS DISPARATE ADVERTISING NETWORKS

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US); Richard Burnham Lanman, London (GB)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/753,790

(22) Filed: May 25, 2007

Related U.S. Application Data
(60) Provisional application No. 60/862,969, filed on Oct. 25, 2006.

(51) Int. Cl. G06Q 40/00

(52) U.S. Cl. 705/37

(57) ABSTRACT

An optimization tool is provided for individual participants who participate in multiple online advertising environments wherein the tool interfaces with the multiple environments in an optimal manner on behalf of the individual participants. A participant using the tool can specify goals and/or constraints for participating in one or more of the networks, and then the tool automatically optimizes advertising expenditure for advertising transactions across the different networks. The tool also tracks the performance of the participant across the different networks and dynamically tunes the participant's advertising expenditure based on such performance as well as the changing conditions of the marketplace.

### CROSS REFERENCE TO RELATED APPLICATIONS

This application claims priority to U.S. Patent Application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

The subject disclosure relates to an advertising tool that automatically optimizes advertising strategies on behalf of a user with respect to disparate advertising networks.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. As one example, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Finally, as mentioned, the Google example is only a single example of an advertising network. In this regard, many different other companies have formed advertising networks and affiliations as well. As a natural outgrowth of the emergence of different advertising networks, participants, i.e., potential advertisers, are faced with a complex question regarding how to best spend their advertising dollars. Today, a merchant advertising in a first advertising network with 50% of its advertising budget and advertising in a second advertising network with 50% of its advertising budget might be able to manually compare how the different advertising networks are performing, however, when a non-trivial number of advertising networks are involved, and percentages of advertising spends are not equal, the comparison for the merchant becomes considerably more complex. Thus, what is desired is a tool that helps participants in different advertising networks to automatically optimize their advertising spend given one or more advertising goals specified by the participants.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

The invention provides a tool for participants who participate in multiple online advertising environments that interfaces with the multiple environments in an optimal manner. A participant using the tool can specify goals and/or constraints for participating in one or more of the networks, and then the tool automatically optimizes advertising expenditure for advertising transactions across the different networks. The tool also tracks the performance of the participant across the different networks and dynamically tunes the participant's advertising expenditure based on such performance as well as the changing conditions of the marketplace.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the tool for optimizing advertising across different advertising networks in accordance with the present invention are further described with reference to the accompanying drawings in which:

FIG. 1 is a block diagram illustration of a difficulty facing individual participants in multiple, disparate advertising networks;

FIG. 2 is a block diagram of a tool provided in accordance with the invention for optimizing advertising expenditure of individual participants across disparate advertising participants;

FIG. 3 is a block diagram showing an input component for entering participant objectives in accordance with the invention;

FIGS. 4A and 4B are block diagrams showing the impact of different choices of participation objectives by an individual participant in accordance with the invention;

FIGS. 5A and 5B are block diagrams showing an exemplary architecture for expressing objectives and/or constraints on those objectives, and analysis of past transactions and marketplace feedback in accordance with the invention;

FIGS. 6A and 6B are block diagrams showing another exemplary architecture for expressing objectives and/or constraints on those objectives, and analysis of past transactions and marketplace feedback in accordance with the invention;

FIG. 7 illustrates application of the tool of the invention to a publishing entity;

FIG. 8 is a flow diagram of an exemplary, non-limiting process for interacting with multiple different advertising networks in accordance with the invention;

FIG. 9 is a block diagram illustrating the creation of a normalized marketplace when the tool of the invention is used by many participants;

FIG. 10 is a block diagram illustrating the disabling of existing advertising networks and enabling of new advertising networks for disuse or use by the tool of the invention;

FIG. 11 is another flow diagram of an exemplary, non-limiting process for interacting with multiple different advertising networks in accordance with the invention;

FIG. 12 is a block diagram of a computing system environment suitable for use in implementing the present invention;

FIG. 13 illustrates an exemplary architecture for an advertising network according to embodiments of the present invention;

FIG. 14 illustrates a flowchart of the operation of a bidding process, according to exemplary, non-limiting embodiments of the present invention; and

FIG. 15 illustrates the operation of an advertising network to match inventory with bids in accordance with advertising transactions within the advertising network.

### DETAILED DESCRIPTION

### Overview

In various non-limiting embodiments, the invention is described in the context of online advertising markets, i.e., market mechanisms that manage advertising goods among multiple participants on the advertising and/or publishing side. In consideration of the limitations on optimizing expenditure across different markets as described in the background, the invention provides a tool for an individual participant for optimizing advertising expenditure across different advertising markets on behalf of the participant based on one or more criteria specified by the participant.

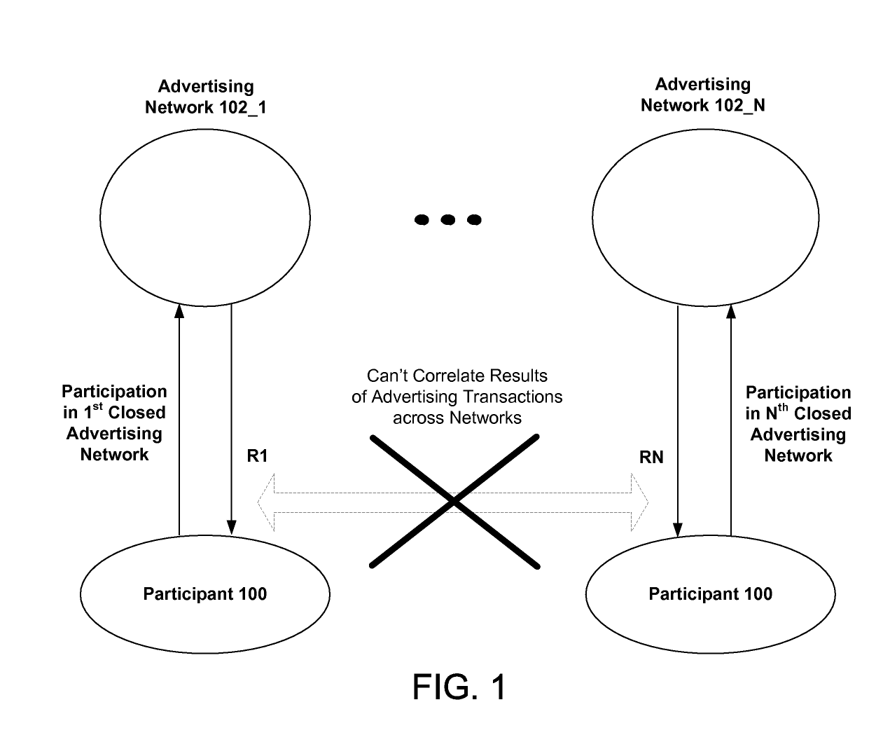

As mentioned in the background, a problem facing participants with respect to different advertising networks is shown generally in FIG. 1. In FIG. 1, participant 100 is an entity that wishes to spend advertising dollars based on goal(s) of the entity. For instance, participant 100 could be a merchant, such as Amazon.com or Expedia.com, which wishes to bid on keyword advertising for products offered at their site. Today, participant 100 is faced with a variety of independent advertising networks 102_1, . . . , 102_N that have different rules, comprise different advertising and publishing entities, and provide different experiences and results. Moreover, the relative strengths of the different advertising networks change over time as different members join or leave the networks. In addition, different participants of the same advertising network may receive different results because of differing goal(s) of the participants. Thus, at bottom, participant 100 is faced with independent participation in multiple networks 102_1, . . . , 102_N and will receive back corresponding different results R1, . . . , RN from the networks 102_1, . . . , 102_N, which creates a widely ranging, variant and unpredictable advertising spending problem for participant 100.

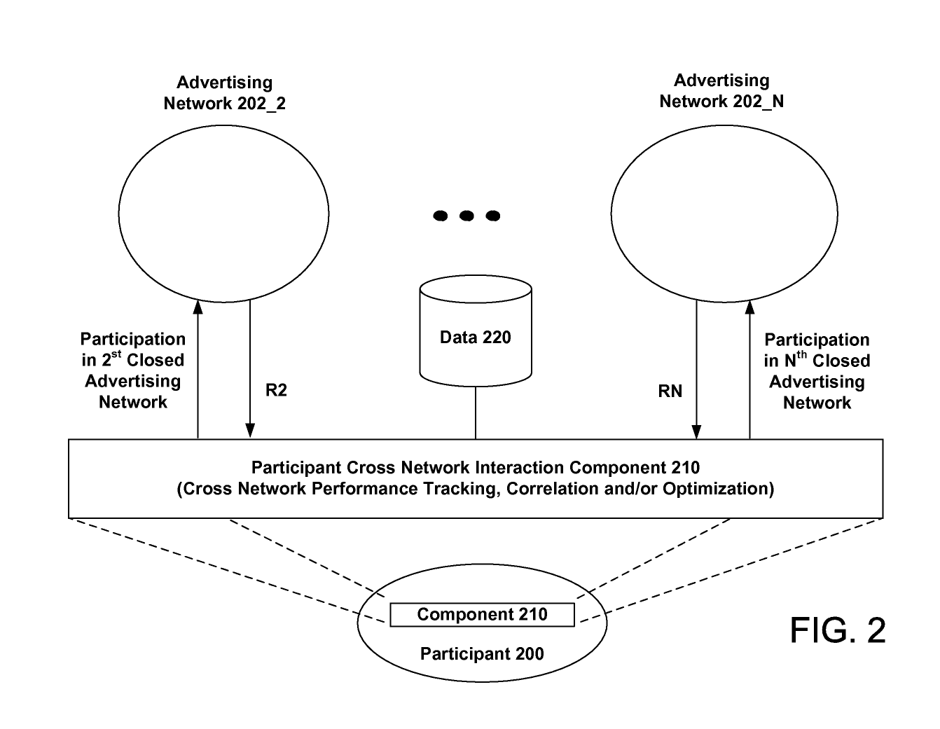

Accordingly, as shown in FIG. 2, the invention provides a component 210, e.g., a software tool, to a participant 200 that enables participant 200 to automatically optimize its advertising spend across the different advertising networks 202_1, . . . , 202_N, thereby realizing greater value per advertising dollar spent. Component 210 includes the communication interfaces to communicate with each of the advertising networks 202_1, . . . , 202_N, or a selected subset, on behalf of participant 200. By continually tracking performance data recorded for each of the different advertising networks 202_1, . . . , 202_N for participant 200, over time, the correlations between the results across the different advertising networks 202_1, . . . , 202_N become more accurate, thereby reducing variance associated with expected outcome for participant 200. Put simply, component 210 optimizes how participant 200 should spend advertising dollars on different advertising inventory offered by different advertising networks 202_1, . . . , 202_N, and in what percentages, by analyzing changing market conditions (e.g., responding to increases in volume available at another network) and analyzing performance and correlation data 220 associated with results R1, . . . , RN delivered by the different networks 202_1, 202_N.

Accordingly, in various non-limiting embodiments, the invention provides a wizard or tool that helps a participant optimize advertising expenditure. Over time, the performance of the different networks can be measured over time as a function of the goals selected by the participant so that it might be observed that a participant overutilizing a particular network to the disadvantage of better pricing or results in another network.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Tool for Optimizing Advertising Expenditure for Participants of Multiple Advertising Networks

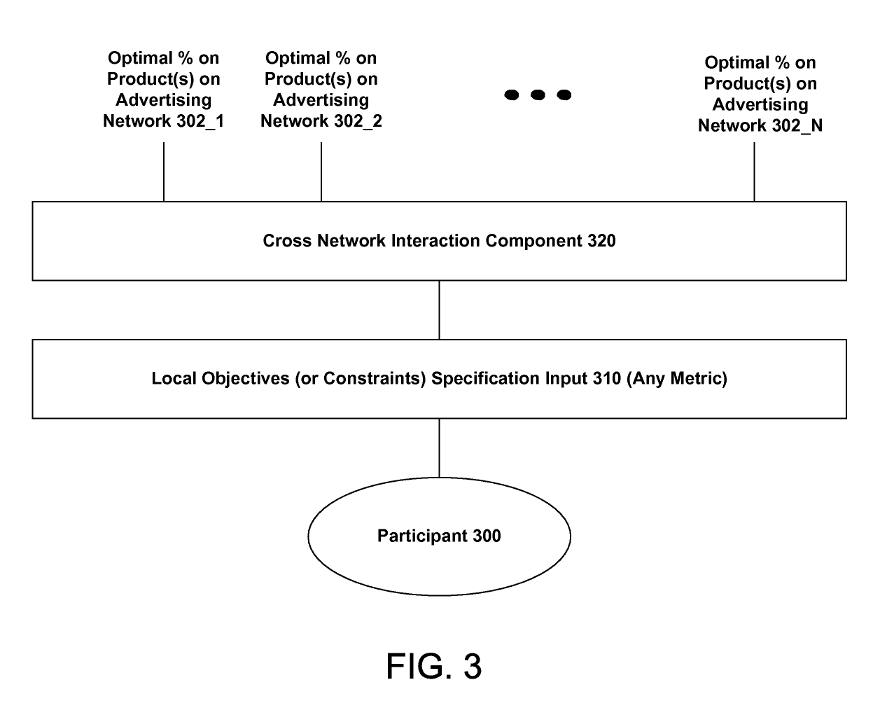

As mentioned, the invention provides a tool for participants of different advertising networks to optimize their participation in the different networks relative to their participation goals, which is generally illustrated in FIG. 3. The tool of the invention may include or communicate with a component 310 for inputting a participant's objectives with respect to advertising. This may be based on any metric that can be quantified in the marketplace, e.g., different revenue expressions, metric based on quality, relevance, volume, etc. Some non-limiting examples include metrics with respect to the following characteristics of advertising transactions: Price, Volume or growth rate, Availability of supply, Availability of demand, Clickthrough rate (CTR), Conversion rate (or any other performance metric), Display properties, Reach, Relevance or Interest Level, etc.

In one embodiment, a profile for participants is derived for participants by input component 310 based on one or more local objectives or utility functions expressed by the participant for overall participation. The profile enables the tool of the invention to determine transactions that are likely to be optimal for that participant's needs based on expected return. More specifically, the profile is input to cross network interaction component 320 of the tool of the invention, which then determines an optimal advertising spend across different advertising networks for the participant 300. The tool thus examines each of the networks 302_1, 302_2, . . . , 302_N, and based on the participant 300's profile or goals, the tool determines optimal participation across the different networks automatically.

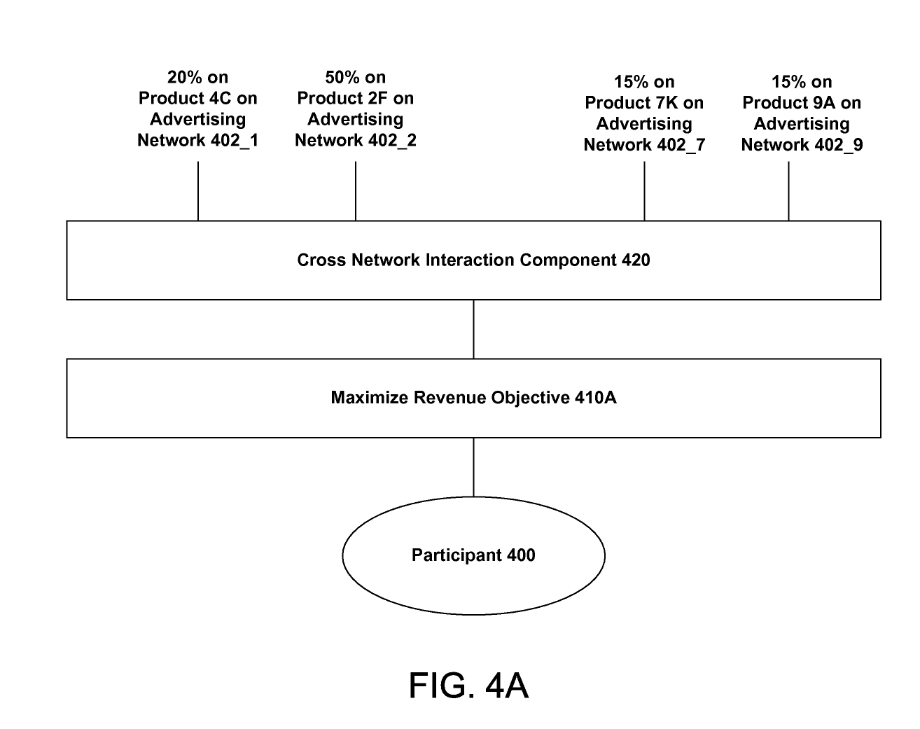

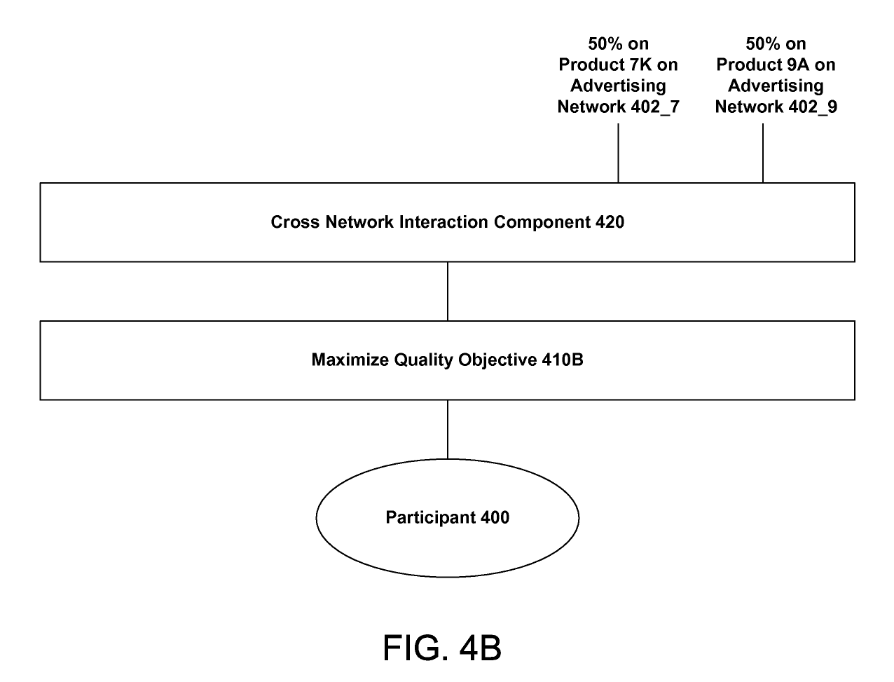

For example, as shown in FIG. 4A, participant 400 might specify a goal 410A that participant 400 wishes to maximize only revenue. Based on a goal of revenue maximization, cross network interaction component 420 determines that participant 400 should spend 20% of its advertising spend budget on product 4C from advertising network 402_{—1,} 50% of its advertising spend budget on product 2F on advertising network 402_{—2,} 15% of its advertising spend budget on product 7K on advertising network 402_{—7,} 15% of its advertising spend budget on product 9A on advertising network 402_9 and zero percent on all other networks, where products are advertisement space or other publishing inventory.

The power of the tool of the invention is further illustrated with reference to FIG. 4B, where participant 400 has changed its goals of participation from goal 410A to maximize revenue to goal 410B indicating that participant 400 wishes to maximize quality of advertisement space instead. This causes the cross network interaction component 420 to re-optimize the participant's advertising expenditure for a given budget. In this case, based on a goal of maximizing quality, cross network interaction component 420 determines that participant 400 should spend 50% of its advertising spend budget on product 7K on advertising network 402_7, 50% of its advertising spend budget on product 9A on advertising network 402_9 and zero percent on all other networks.

As another example, participant 400 might want display quality to remain premium in order to preserve the value of company brand, in which case a different optimal advertising expenditure results.

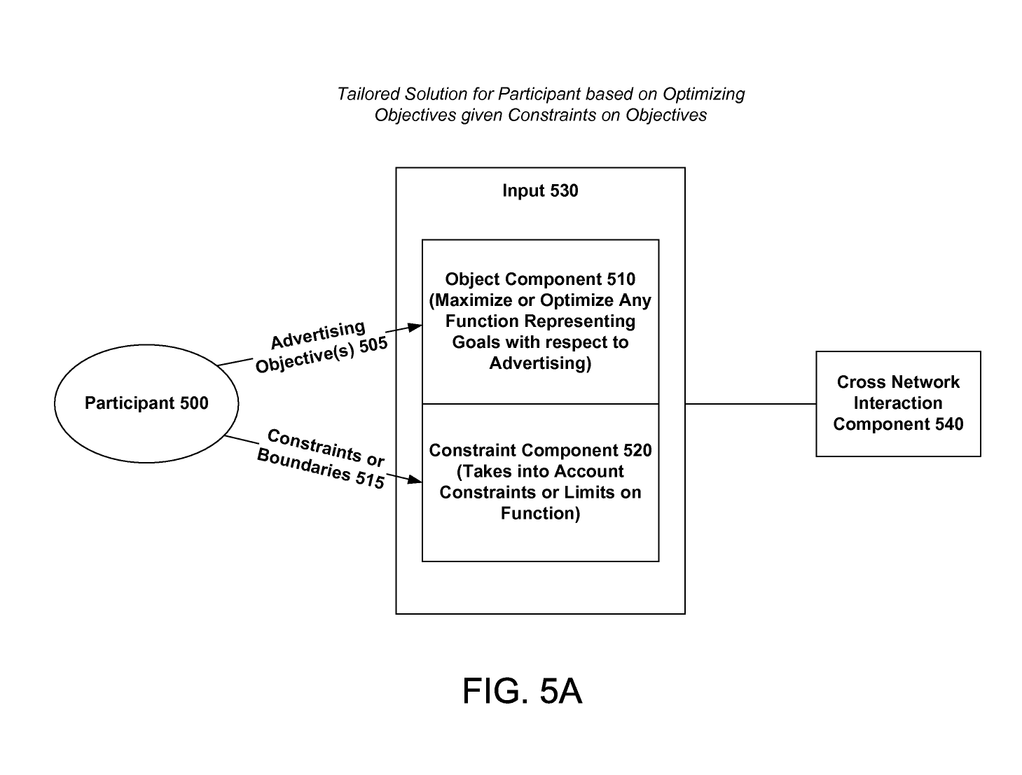

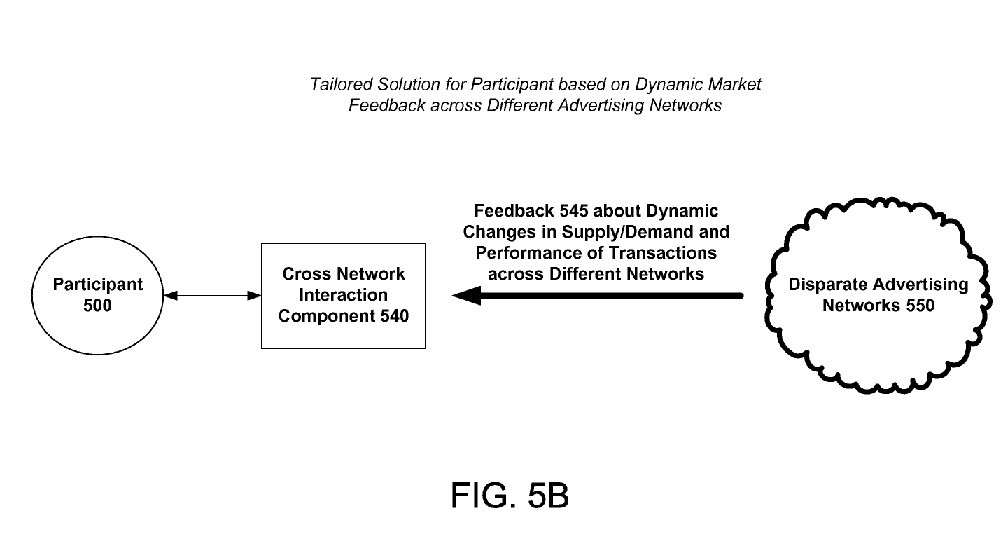

In one embodiment, as shown in FIG. 5A, participant 500 specifies goals for participation across the different advertising networks according to a constraint/optimization solution. Under this view, a participant 500 specifies positive advertising objective(s) 505 such as maximize revenue, or maximize quality, and yet, participant 500 may not want to maximize the same goals or objectives in all instances. Thus, for flexibility, participant 500 may also wish to additionally specify constraints or boundaries on those goals or objectives 505. Thus, the objective input component 530 resolves the goals 505 received by object component 510 taking into account constraint component 520 to form a participation profile that is analyzed by cross network interaction component 540 when participating in the different networks to purchase advertising on behalf of participant 500.

Thus, in accordance with the invention, a participant can express its goals for participating across the different advertising networks, and the tool of the invention will automatically optimize advertising expenditure to meet the goals of the participants when conducting transactions in the different advertising networks. In addition, as shown in FIG. 5B, the tool of the invention can become smarter over time by examining feedback 545 from the disparate advertising networks 550. Feedback 545 may include information about the ebb and flow of supply and demand represented by the different online advertising networks, as well as performance information about how previous transactions actually performed relative to expected results. Thus, where an unexpected result is obtained, the tool can fine-tune its optimization calculations to account for the new expectations discovered in feedback 545. Accordingly, based on feedback 545 received from the different advertising networks 550, cross network interaction component 540 becomes more intelligent over time yielding more consistent results on behalf of participant 500.

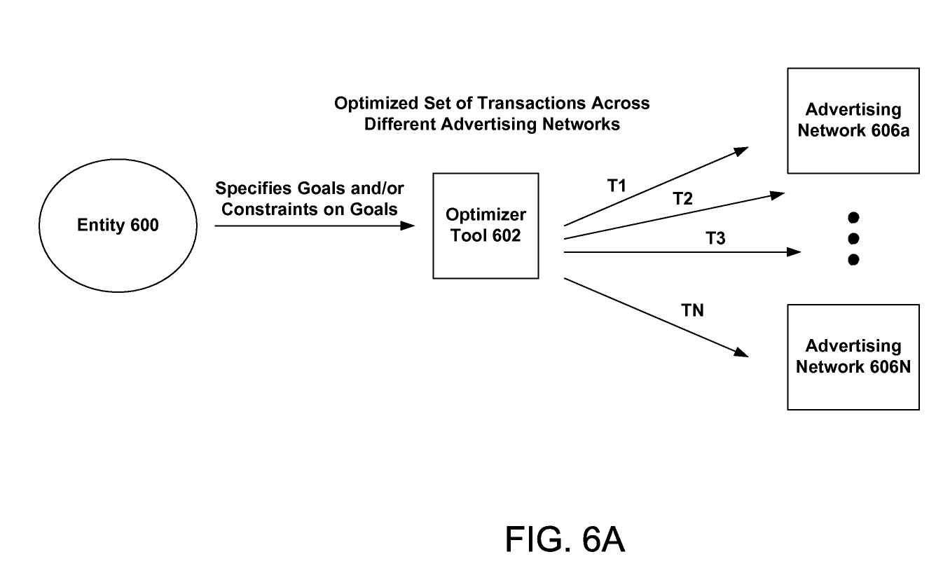

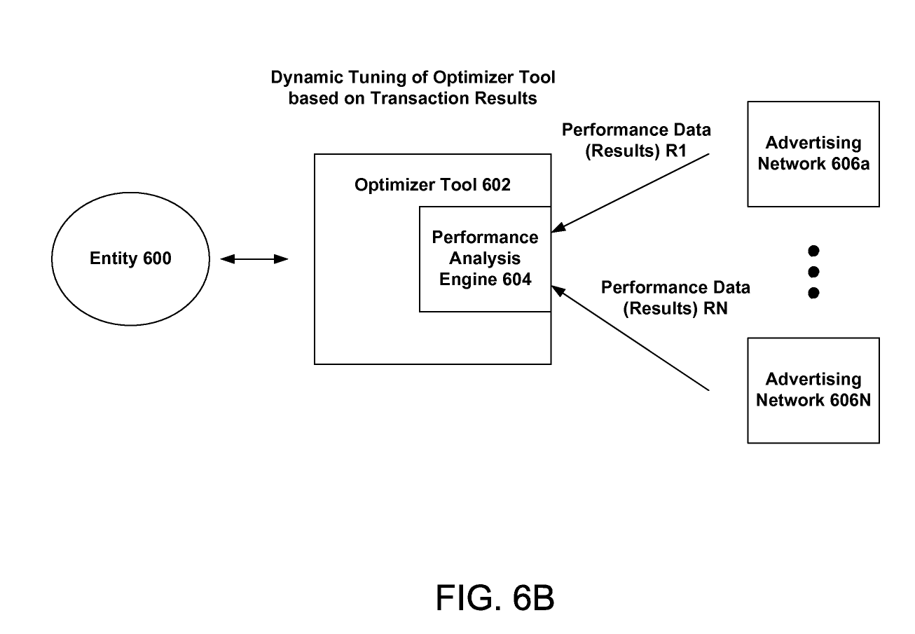

Accordingly, as shown in the exemplary non-limiting block diagram of FIG. 6A, an entity 600, whether advertiser or publisher, specifies goals and/or constraints on those goals to an optimizer tool 602, which then automatically conducts transactions T1, T2, T3, . . . , TN on behalf of entity 600 in advertising networks 606a, . . . , 606N in an optimal manner based on those goals and/or constraints.

Furthermore, as described above, and shown in FIG. 6B, the tool of the invention may include a performance analysis engine 604 that analyzes the results R1, . . . , RN returned by advertising networks 606a, . . . , 606N relative to expected results. Tool 602 then takes into account any revisions to expected results based on the analysis of the actual results R1, . . . , RN when optimizing entity 600's advertising expenditure.

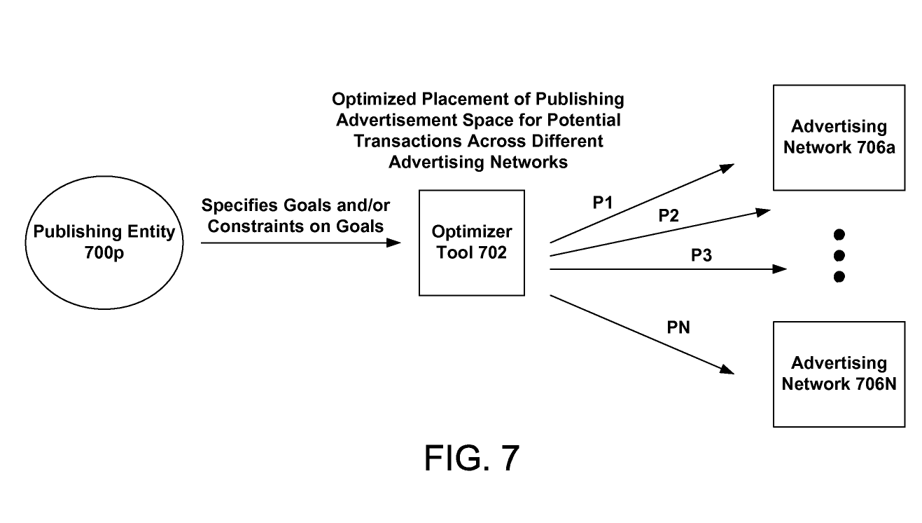

While many of the examples of the tool of the invention are described herein in the context of advertisers, such a tool can also be provided to publishers who wish to make advertisement space available on multiple networks. For instance, publishers can also make their objectives known to the tool, and then the tool of the invention operates to optimally place the advertisement space across different advertising networks based on the publishing objectives. For instance, a publisher's goal may be to have only high quality advertisements on its advertisement space. In such case, the quality of the advertisements of the different advertising networks dynamically can be taken into account when conducting transactions in the different advertising networks. This is illustrated in FIG. 7 showing the optimized placement of publishing advertisement space for potential transactions across different advertising networks 706a, . . . , 706N. Publishing entity 700p specifies participation goals and/or constraints that are taken into account when optimizer tool 702 optimizes the placement of inventory on behalf of the publishing entity 700p.

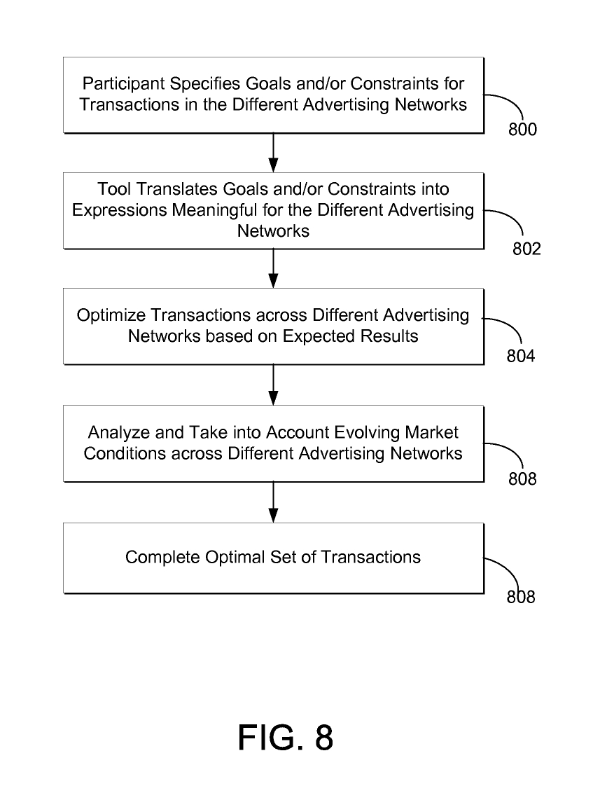

The above-described embodiments of an optimization tool in accordance with the invention are further described with reference to the flow diagram of FIG. 8. At 800, a participant specifies goals and/or constraints for participating in transactions in multiple different advertising networks via the tool of the invention. This can be done directly, e.g., “Nothing but quality of at least X on quality metric scale Y” or “Price not to exceed $X/unit advertising.” Or this can be done indirectly, e.g., “I wish to maximize reach” which implicitly specifies limits on transactions under or over which the participant does not wish to go.

Then at 802, the tool translates the goals and/or constraints that are meaningful to the different advertising networks. For instance, a first advertising network might conduct transactions according to a first way of expressing currency (e.g., cost per click, or CPC, and a second advertising network might conduct transactions according to a second way of expressing advertising currency (e.g., cost per impression, or CPI). This way, the participant can express its goals and/or constraints on participating without worrying about the underlying details of how to express those goals and/or constraints to the different advertising network because the tool handles such translation automatically.

At 804, the tool optimizes a set of potential transactions for the participant across the different advertising networks based on expected results that cater to the participant's goals. The tool of the invention, at 806, also analyses and takes into account any evolving market conditions across the different advertising networks. At 808, the tool completes an optimal set of transactions on the participant's behalf.

Over time, the performance of the transactions completed on behalf of the participant can be measured as a function of the goals of the participant. For instance, over time, it might be observed that a participant is underspending on a certain network and overspending on another network, and is in effect paying a penalty for a suboptimal advertising spend. Thus, a performance analysis engine of the invention advantageously maintains performance information about different transactions conducted by the participant in the marketplace, thereby over time, becoming more knowledgeable about the best advertising networks and corresponding products for meeting the participant's goals. In such a case, a tool in accordance with the invention can dynamically tune the participant's advertising expenditure to wherever the participant is receiving the best results in practice. Thus, the tool of the invention becomes smarter over time.

As mentioned, there are a variety of pricing models that could form the basis of an advertising goal or preference in accordance with the invention. For instance, an entity may specify terms that include different pricing models, such as a term that specifies an upper limit on quality in terms of a cost per click (CPC) pricing model and another terms that specifies a range within which the participant wishes to stay for a transaction according to a cost per impression (CPI) pricing model. At the same time, yet another goal may include terms specified according to a cost per acquisition (CPA) pricing model. The tool of the invention can optionally translate between the different expressions for use in connection with optimizing transactions across the different advertising networks.

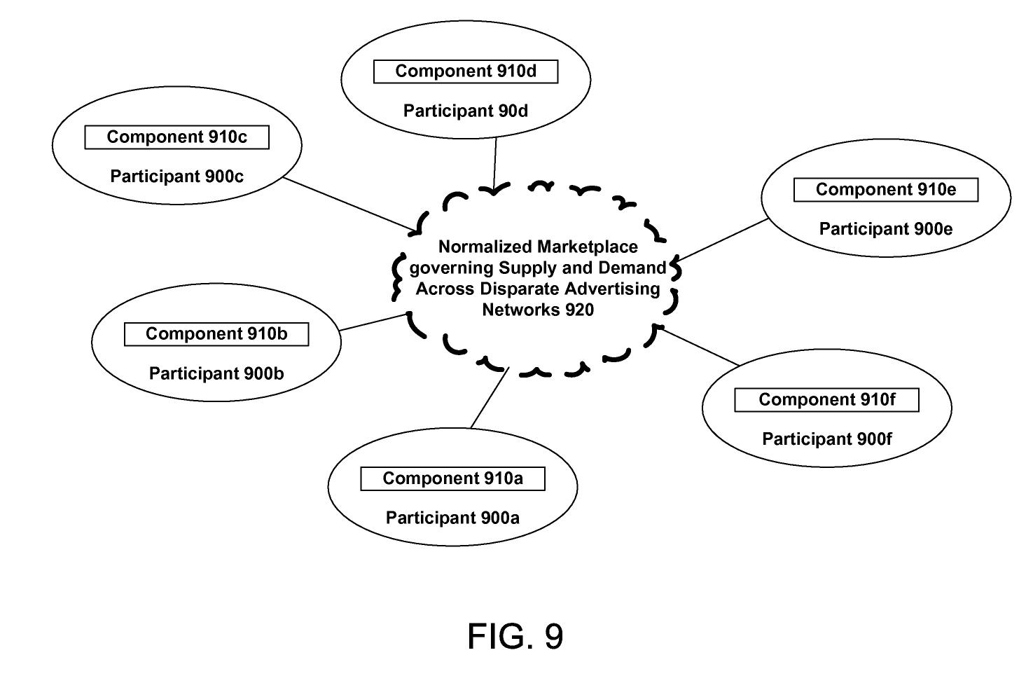

Accordingly, in various non-limiting embodiments, the invention provides systems and methods for facilitating trading of advertising by a participant in multiple disparate networks by reducing the amount of difficult decision making made by participants that independently participate in different advertising networks. As shown in FIG. 9, a tool in accordance with the invention can be provided to many participants that face the same problem of participating ad hoc in different networks without any way of automatically determining optimal advertising expenditure. Thus, participants 900a, 900b, 900c, 900d, 900e, 900f, etc. (any number of participants) are each provided with a tool 910a, 910b, 910c, 910d, 910e, 910f, etc.

When more than an insignificant number of participants each trade across the different networks according to their optimal advertising expenditure, a beneficial effect results in accordance with the invention. Namely, since all the participants are purchasing according to optimal strategies, over time, this will cause the marketplace represented by all of the different advertising networks to normalize to a common or similar cost structure. For instance, if one advertising network continues to maintain premium pricing relative to other advertising networks, over time, fewer and fewer purchases will be made at that advertising network by participants. As a result, the advertising network will either have to reduce its pricing to meet other advertising networks, or expect reduced revenue. Thus, one can see that with more and more participants using the tool of the invention, the effect is to create a single normalized marketplace governing supply and demand across all of the disparate advertising networks.

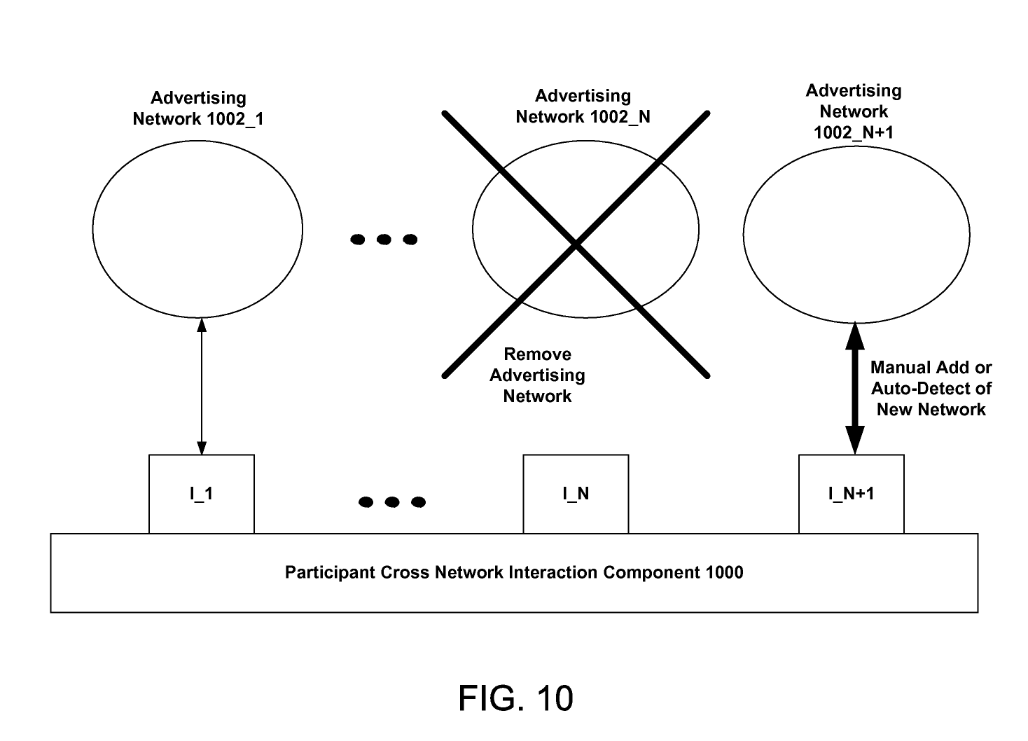

FIG. 10 shows an embodiment of the tool of the invention where the tool 1000 includes different interface I_1, . . . , I_N to a variety of advertising networks 1002_1, . . . , 1002_N. However, the participant may have a reason not to participate in one or more of the advertising networks 1002_1, . . . , 1002_N. For instance, the participant may have a business conflict with participating in Advertising Network 1002_N, in which case the participant can disable the corresponding interface I_N to advertising network 1002_N. In addition, for flexibility, the participant can also enable a new network either manually or automatically where a new advertising network 1002_N+1 can be detected. Accordingly, the participant is provisioned with the ability to optimize its advertising expenditure across a subset of existing advertising networks 1002_1, . . . , 1002_N, while also being able to add new networks, such as advertising network 1002_N+1.

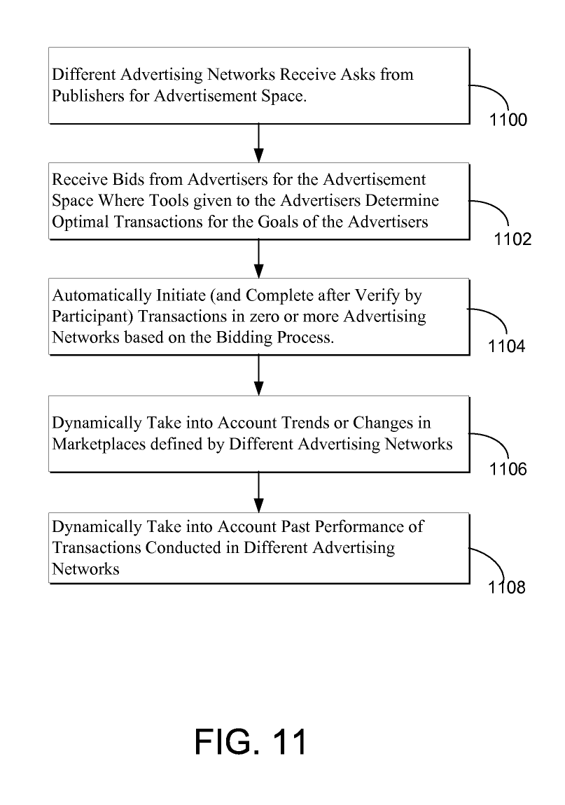

FIG. 11 illustrates yet another non-limiting flow diagram for optimizing advertising expenditure in accordance with the invention in the context of auction bidding in the different advertising networks in accordance with the invention. At 1100, publishers of the various networks submit asks for an advertisement space. At 1102, an advertiser using the tool of the invention submits various bids for the advertisement space based on optimal advertising expenditure given the advertiser's goals. At 1104, one or more transactions are initiated (which may be verified by the advertiser prior to purchase) in any number of the advertising networks based on an optimal advertising expenditure.

At 1106, the tool automatically takes into account trends or changes in the different marketplaces represented by the different advertising networks. At 1108, the tool also dynamically takes into account past performance of transaction conducted in the different advertising networks. In this way, individual participants without much bargaining power individually, can optimize its advertising expenditure in a way that is tailored to the goals of the participant, and which automatically plays competitive advertising networks against one another to encourage the formation of normalized pricing of advertising across the different networks.

### Exemplary Operating Environment(s)

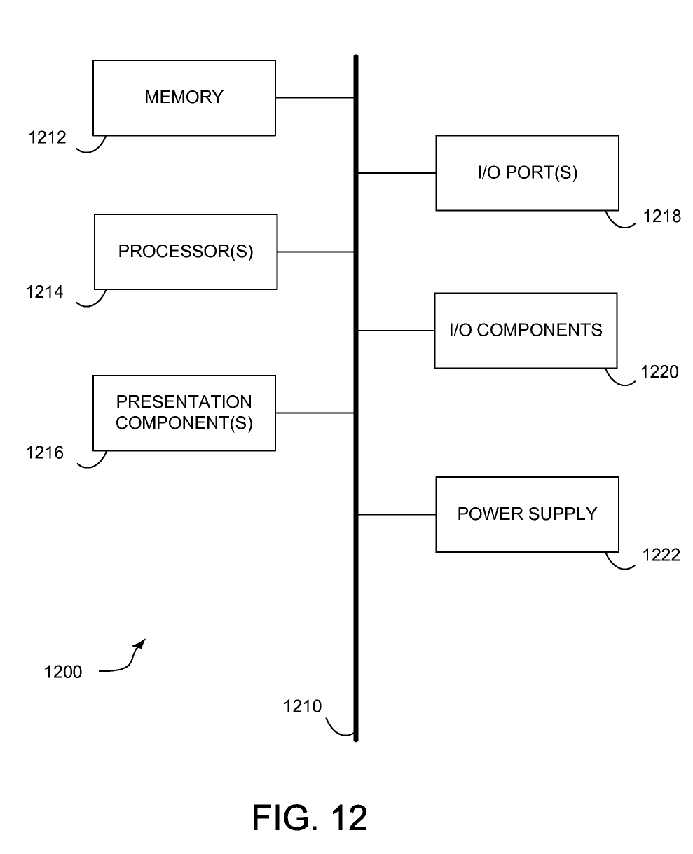

Referring initially to FIG. 12 in particular, an exemplary operating environment for implementing embodiments of the present invention is shown and designated generally as computing device 1200. For instance, the above-described embodiments of the tool may be executed on a device 1200. Computing device 1200 is but one example of a suitable computing environment and is not intended to suggest any limitation as to the scope of use or functionality of the invention. Neither should the computing environment 1200 be interpreted as having any dependency or requirement relating to any one or combination of components illustrated. In accordance with the invention, participants can communicate with advertising networks via one or more computing devices 1200, and the advertising networks may also comprise one or more computing devices 1200, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 12, computing device 1200 includes a bus 1210 that directly or indirectly couples the following elements: memory 1212, one or more processors 1214, one or more presentation components 1216, input/output ports 1218, input/output components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 1200.

Memory 1212 includes computer-storage media in the form of volatile and/or nonvolatile memory. The memory may be removable, nonremovable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc.

### Exemplary Advertising Network(s) for Online Advertising

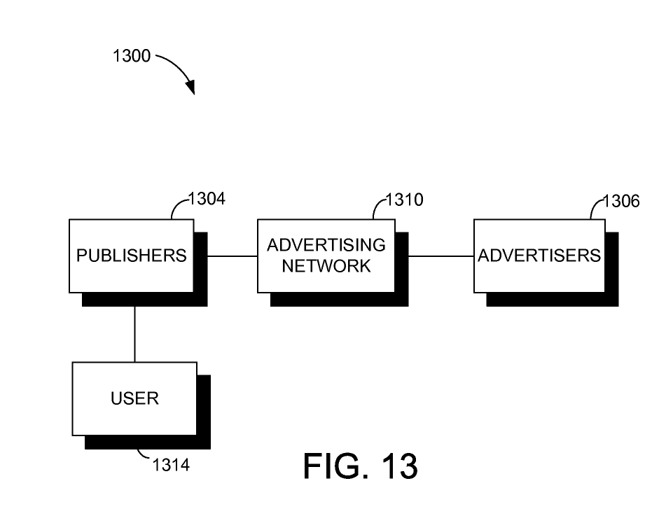

Exemplary online advertising networks in connection with which one or more of the various embodiments of the present invention may be deployed or implemented are now described. For instance, FIG. 13 illustrates an exemplary network 1300 for online advertising, which comprises a marketplace for publishers 1302 and advertisers 1306. For purposes of explanation only, publishers 1302 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in network 1300.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 1302 is intended to represent any number of types, sizes, sophistication levels, etc. of publishers. In an embodiment, publishers 1302 desire to sell advertisement space on their websites to advertisers 1306 (discussed below).

Network 1300 also comprises advertisers 1306. For purposes of explanation only, advertisers 1306 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in network 1300.

In an embodiment, each advertiser purchases ad space on websites. For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 1306 is intended to represent any number of types, sizes, sophistication levels, etc. of advertisers. In an embodiment, advertisers 1306 desire to pay money to place ads on publishers 1302's websites.

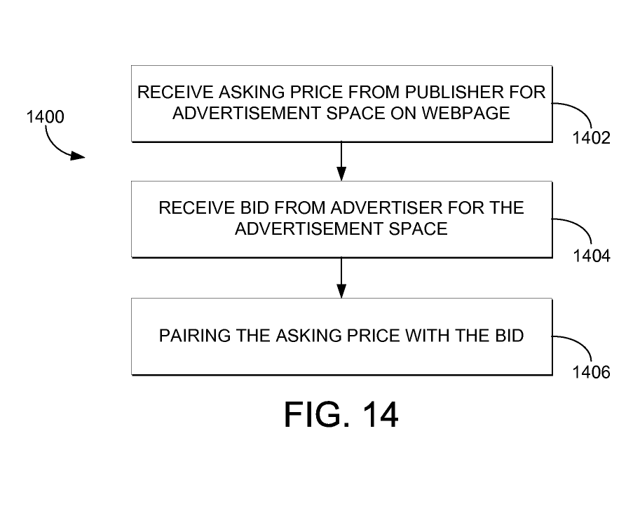

FIG. 14 illustrates a flowchart of the operation of a network according to embodiments of the present invention. Referring to FIG. 14, method 1400 begins with the receipt of an ask from a publisher for advertisement space on a webpage (1402). A bid is received from an advertiser for the advertisement space (1404). In an embodiment, bids are received from many different advertisers. The ask is paired with one of the bids (1406) and the advertisement space on the webpage is awarded to the winning bidder.

Accordingly, in non-limiting embodiments, the invention includes a system to facilitate trading of advertising by having publisher(s) that determine an ask for an advertisement space on the publisher(s)' webpages. The network of the invention then facilitates transactions for advertisement space between the publishers and the advertisers.

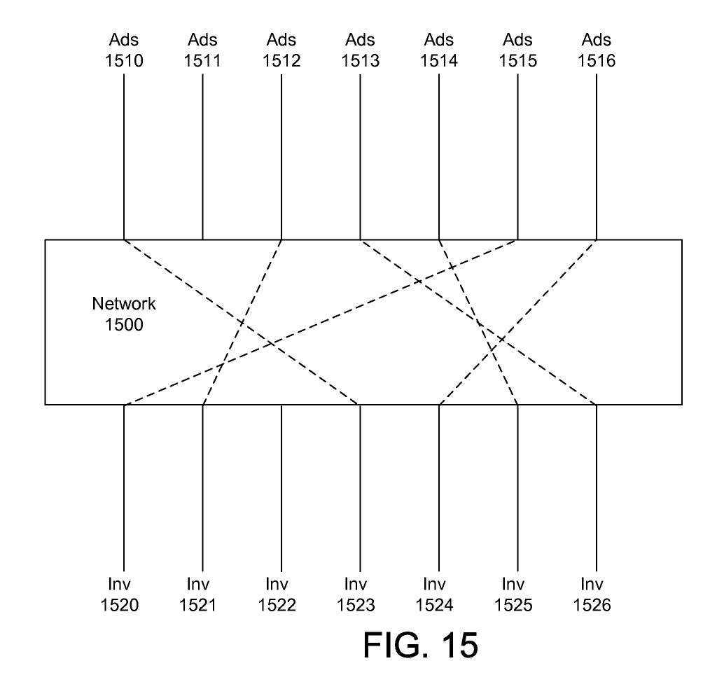

This is illustrated in FIG. 15 showing an exemplary advertising network 1500 that accommodates a wide range of advertising 1510, 1511, 1512, 1513, 1514, 1515, 1516, etc. from a wide range of parties, and also accommodates a wide range of inventory 1520, 1521, 1522, 1523, 1524, 1525, 1526, etc. from a wide range of parties. Network 1500 matches advertising content with inventory. While various non-limiting embodiments of the invention are described in the context of two parties herein, this is for ease of conceptual presentation. It can be appreciated that the invention can be provided for any arbitrary number of advertising entities. The invention may also be implemented in a peer-to-peer architecture, wherein processing performed by the tool of the invention is shared across multiple participating machines.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method of facilitating trading of advertising for an advertiser in multiple disparate advertising networks, comprising:
receiving information about asks from at least one publisher for at least one advertisement space placed on at least one advertising network of a plurality of disparate advertising networks;
receiving at least one objective for bidding for the at least one advertisement space placed on the at least one advertising network; and
based on the at least one objective, analyzing the asks from the at least one publisher for the at least one advertisement space across the disparate advertising networks and automatically optimizing the bidding for the at least one advertisement space on behalf of the advertiser.

2. The method of claim 1, wherein said optimizing includes optimizing the bidding for the at least one advertisement space taking into account performance data about past transactions.

3. The method of claim 1, wherein said optimizing includes optimizing the bidding for the at least one advertisement space taking into account dynamically changing market conditions represented by the at least one advertising network.

4. The method of claim 1, further comprising:
translating the at least one objective to different expressions corresponding to on the different advertising networks.

5. The method of claim 1, wherein the receiving of the at least one objective includes receiving a specification of at least one constraint on the at least one objective.

6. The method of claim 1, further comprising:
disabling bidding with respect to a designated advertising network of the plurality of advertising networks.

7. The method of claim 1, further comprising:
enabling bidding with respect to a designated new advertising network in addition to the plurality of advertising networks.

8. The method of claim 1, further comprising:
completing at least one transaction based on the optimized bidding for the at least one advertisement space.

9. The method of claim 8, further comprising:
waiting for confirmation of the at least one transaction prior to said completing.

10. A tool to facilitate trading of advertising for an advertising entity in multiple disparate advertising networks, comprising:
an input component for receiving input from the advertising entity about at least one objective for advertising transactions across the different advertising networks; and
an analysis engine that optimizes advertising expenditure of the advertising entity across the different advertising networks based on the at least one objective.

11. The tool of claim 10, wherein the input component receives a specification of a function of the quality of advertising involved in advertising transactions, and wherein the analysis engine optimizes advertising expenditure of the advertising entity based on the function.

12. The tool of claim 10, wherein the input component receives a specification of a function of the size of other participants in advertising transactions involved in advertising transactions, and wherein the analysis engine optimizes advertising expenditure of the advertising entity based on the function.

13. The tool of claim 10, wherein the input component receives a specification of a function of display characteristics of the publishing inventory involved in advertising transactions, and wherein the analysis engine optimizes advertising expenditure of the advertising entity based on the function.

14. The tool of claim 10, wherein the input component receives a specification of a function of the relevance of advertising involved in advertising transactions involved in advertising transactions, and wherein the analysis engine optimizes advertising expenditure of the advertising entity based on the function.

15. The tool of claim 10, wherein the input component receives a specification of a function of a performance metric of advertising or publishing inventory involved in advertising transactions involved in advertising transactions, and wherein the analysis engine optimizes advertising expenditure of the advertising entity based on the function.

16. The tool of claim 10, wherein the analysis engine optimizes the advertising entity's bids for advertisement space by taking into account performance data about past transactions by the advertising entity in the different advertising networks.

17. The tool of claim 10, wherein the analysis engine optimizes the advertising entity's bids for advertisement space taking into account dynamically changing market conditions represented by the different advertising networks.

18. The tool of claim 10, wherein the input component receives at least one constraint on the at least one objective and the analysis engine optimizes advertising expenditure of the advertising entity across the different advertising networks based on the at least one objective and the at least one constraint on the at least one objective.

19. A method of facilitating trading of advertising for an individual publisher in multiple disparate advertising networks, comprising:
analyzing performance data associated with results of transactions conducted in the multiple disparate advertising networks; and
specifying at least one objective for asking for at least one advertisement space placed on the at least one advertising network by the publisher; and
based on the at least one objective, on behalf of the publisher, optimizing asks for the at least one advertisement space across the different advertising networks based on the analyzing.

20. The method of claim 19, further comprising:
analyzing changes in market conditions of the multiple disparate advertising networks; and
optimizing asks on behalf of the publisher across the different advertising networks based on the analyzing of the changes in market conditions.
